(19) United States
(12) Patent Application Publication
(10) Pub. No.: US 2016/0011782 A1
(43) Pub. Date: Jan. 14, 2016

(54) SEMICONDUCTOR STORAGE

(71) Applicant: HITACHI, LTD., Chiyoda-ku, Tokyo (JP)

(72) Inventors: Kenzo KUROTSUCHI, Tokyo (JP); Seiji MIURA, Tokyo (JP); Hiroshi UCHIGAITO, Tokyo (JP)

(21) Appl. No.: 14/771,153

(22) PCT Filed: Feb. 27, 2013
(86) PCT No.: PCT/JP2013/055030

§ 371 Date: Aug. 27, 2015

(51) Int. Cl. G06F 3/06; G06F 12/10

(52) U.S. Cl. CPC G06F 3/064; G06F 3/0616; G06F 3/0679; G06F 12/1009; G06F 2212/2022

(57) ABSTRACT

A first objective is to reduce performance degradation of a semiconductor storage resulting from address translation. A second objective is to reduce an increase in the manufacturing cost of the semiconductor storage resulting from address translation. A third objective is to provide the semiconductor storage with high reliability. To accomplish the above objectives, a storage area of a nonvolatile memory included in the semiconductor storage is segmented into multiple blocks, and each of the blocks is segmented into multiple pages. Then, an erase count is controlled on a page basis (109), and address translation is controlled on a block basis (108).

### TECHNICAL FIELD

The present invention relates to a semiconductor storage. More particularly, the present invention relates to a semiconductor storage including an electrically rewritable memory cell, which is capable of storing information by means of a difference in a resistance value.

### BACKGROUND ART

A semiconductor storage (hereinafter referred to as a solid state drive (SSD)) has been widely used as an alternative storage device for a hard disk, or a storage device in a digital camera, a portable music player, and the like. While a capacity of a memory device has been increasing year by year, there is a demand for a storage device with a larger capacity, as a storage is required to manage an increasing amount of data, for reasons such as a higher pixel density in a digital camera, a higher sound quality of a portable music player, need for handling video data, and merging of broadcasting and communication.

An SSD includes a nonvolatile memory, and an SSD controller. An SSD may also have a dynamic random access memory (DRAM). Generally, the nonvolatile memory has a certain finite number of program/erase cycles. Therefore, the SSD implements a process (wear leveling) so that program operations are distributed evenly over the nonvolatile memory. In order to implement wear leveling, an SSD controller translates an address specified by a host to the SSD (hereinafter referred to as a “logical address”) into an address different from the logical address (hereinafter referred to as a “physical address”) so as to access a flash memory. NPL 1 describes a method for translating a logical address into a physical address by means of an address translation table.

An NAND type flash memory having a multilayer gate structure is mainly used at present as a nonvolatile memory. The NAND type flash memory stores information by accumulating charge in the multilayer gate structure and by setting ‘0’ or ‘1’ depending on the quantity of the accumulated charge.

PTL 1 describes a phase change memory, as another nonvolatile memory. The phase change memory uses a phase change material as a storage part. The phase change material has two metastable states, i.e., a high electric resistance phase, and a low electric resistance phase. The phase change memory stores information by setting ‘0’ or ‘1’ depending on the different resistance values. In addition, NPL 2 describes a resistance random access memory (ReRAM) having a storage part using a metal oxide. The ReRAM stores information by changing electric resistance by application of a voltage.

Further, NPL 3 describes a spin transfer torque magnetoresistive random access memory (MRAM) having a storage part using a magnetic material. The MRAM stores information by changing resistance in a storage part by means of magnetization reversal caused by application of an electric current.

PTL 2 describes a semiconductor device in which improvement in memory use efficiency can be achieved through a phase change memory.

All the above-mentioned memories have limits to the number of program/erase cycles. Additionally, in the phase change memory, the ReRAM, and the spin transfer torque MRAM, an erase unit is or can be smaller than in the NAND type flash memory.

### CITATION LIST

### Patent Literature

PTL 1: WO 2011/074545 A1

PTL 2: WO 2010/038736 A1

### Non-Patent Literature

NPL 1: “Write amplification analysis in flash-based solid state drives”, Proceedings of The Israeli Experimental Systems Conference (SYSTOR) (2009), pp. 1-9

NPL 2: “Novel colossal magnetoresistive thin film nonvolatile resistance random access memory”, International Electron Devices Meeting, 2002

NPL 3: “On-axis scheme and novel MTJ structure for sub-30 nm Gb density STT-MRAM”, International Electron Devices Meeting, 2010

### SUMMARY OF INVENTION

### Technical Problem

In PTL 1, an address translation table is located in the nonvolatile memory, or in the DRAM. When the address translation table is located in the nonvolatile memory, the number of access to the nonvolatile memory increases due to the address translation table. This degrades performance of the SSD. When the address translation table is located in the DRAM, the capacity of the DRAM in the SSD increases by the data size of the address translation table. This raises the cost of the SSD. Moreover, the cost of the SSD could further increase due to the need of a data protection system including a battery backup and a super capacitor, for the purpose of preventing loss of address translation information stored in the volatile DRAM in the event of a sudden power failure.

In view of the foregoing, a first objective of the present invention is to reduce performance degradation of a semiconductor storage caused by address translation. A second objective of the present invention is to reduce an increase in the cost of the semiconductor storage caused by address translation. A third objective of the present invention is to provide the semiconductor storage with high reliability.

### Solution to Problem

A typical example of a solution to the above-described problems according to the present invention is a semiconductor storage including a nonvolatile memory in which a storage area is segmented into multiple blocks, and each of the blocks are segmented into multiple pages. In the semiconductor storage, erase count is controlled on a page basis, and address translation from a logical address to a physical address is performed on a block basis.

### Advantageous Effects of Invention

By the present invention, a highly efficient, low cost, and highly reliable semiconductor storage is provided.

### BRIEF DESCRIPTION OF DRAWINGS

FIG. 1 is a configuration diagram showing an embodiment of a semiconductor storage according to a first embodiment of the present invention.

FIG. 2 is a diagram showing a data size of a table in the semiconductor storage according to the first embodiment of the present invention.

FIG. 3 is a diagram showing a data size of a table in a semiconductor storage for comparison to explain an effect of the present invention.

FIG. 4 is an operation flow chart showing the embodiment of the semiconductor storage according to the first embodiment of the present invention.

FIG. 5 is an operation flow chart showing the embodiment of the semiconductor storage according to the first embodiment of the present invention.

FIG. 6 is a diagram showing block management information used in the embodiment of the semiconductor storage according to the first embodiment of the present invention.

FIG. 7 is a diagram showing an address translation method used in the embodiment of the semiconductor storage according to the first embodiment of the present invention.

FIG. 8 is a diagram showing write data transfer performance of the embodiment of the semiconductor storage according to the first embodiment of the present invention.

FIG. 9 is a diagram showing a total size of data that a host is able to write to an SSD in the embodiment of the semiconductor storage according to the first embodiment of the present invention.

FIG. 10 is a diagram showing an outline of an embodiment of a semiconductor storage according to a second embodiment of the present invention.

FIG. 11 is a diagram showing a configuration of the embodiment of the semiconductor storage according to the second embodiment of the present invention.

FIG. 12 is a diagram showing a need for the embodiment of the semiconductor storage according to the second embodiment of the present invention.

FIG. 13 is an operation flow chart showing the embodiment of the semiconductor storage according to the second embodiment of the present invention.

FIG. 14 is a diagram showing an effect of the embodiment of the semiconductor storage according to the second embodiment of the present invention.

FIG. 15 is a diagram showing an erase count in an embodiment of a semiconductor storage for comparison to explain the effect of the second embodiment of the present invention.

FIG. 16 is a configuration diagram showing an embodiment of a semiconductor storage according to a third embodiment of the present invention.

FIG. 17 is a configuration diagram showing an embodiment of a semiconductor storage according to a fourth embodiment of the present invention.

FIG. 18 is a diagram showing an address translation method in an embodiment of the semiconductor storage according to a fifth embodiment of the present invention.

FIG. 19 is a configuration diagram showing an embodiment of a semiconductor storage according to a sixth embodiment of the present invention.

FIG. 20 is a configuration diagram showing an embodiment of a semiconductor storage according to the sixth embodiment of the present invention.

FIG. 21 is a configuration diagram showing an embodiment of a semiconductor storage according to the sixth embodiment of the present invention.

### DESCRIPTION OF EMBODIMENTS

Embodiments of the present invention are described in detail below, with reference to the attached drawings. In all the drawings for describing the embodiments, the same member is basically indicated by the same reference sign, and a description of the same member will not be repeated.

### First Embodiment

A semiconductor storage according to the embodiment includes a nonvolatile memory. An erase count of the nonvolatile memory is controlled in units of pages. Address translation information is controlled in units of blocks. A nonvolatile memory area is segmented into multiple blocks. The block is segmented into multiple pages. A page is the largest unit among units in which an SSD controller performs an erase operation, a bit-alterable write operation, or a program operation to the nonvolatile memory. When data is stored in a binary fashion with ‘0’ and ‘1’, erasure means filling all bits of data in a page with ‘1’, for example. Bit alterable writing means converting ‘0’ to ‘1’, or ‘1’ to ‘0’. Programming means setting ‘0’ from ‘1’. In addition, it is obvious that multi-level recording can be applied, in which data is stored in a quaternary fashion with four values of ‘3’, ‘2’, ‘1’, and ‘0’, for example. In the SSD using a NAND flash memory, an erase unit is 512 KB, for example. Bit-alterable writing is not very feasible. A program unit is 4 KB, for example. In this case, page size is 512 KB. The page size mentioned herein is defined differently from such a page size as described in a specification sheet of a NAND flash memory.

Hereinafter, erasure, bit-alterable writing, or programming to the nonvolatile memory will be collectively referred to as “write”. The cumulative number of writes to at least part of a page, for example, is used as an erase count. It is obvious that the cumulative number of writes to an area larger than a certain area of a page is used as an erase count.

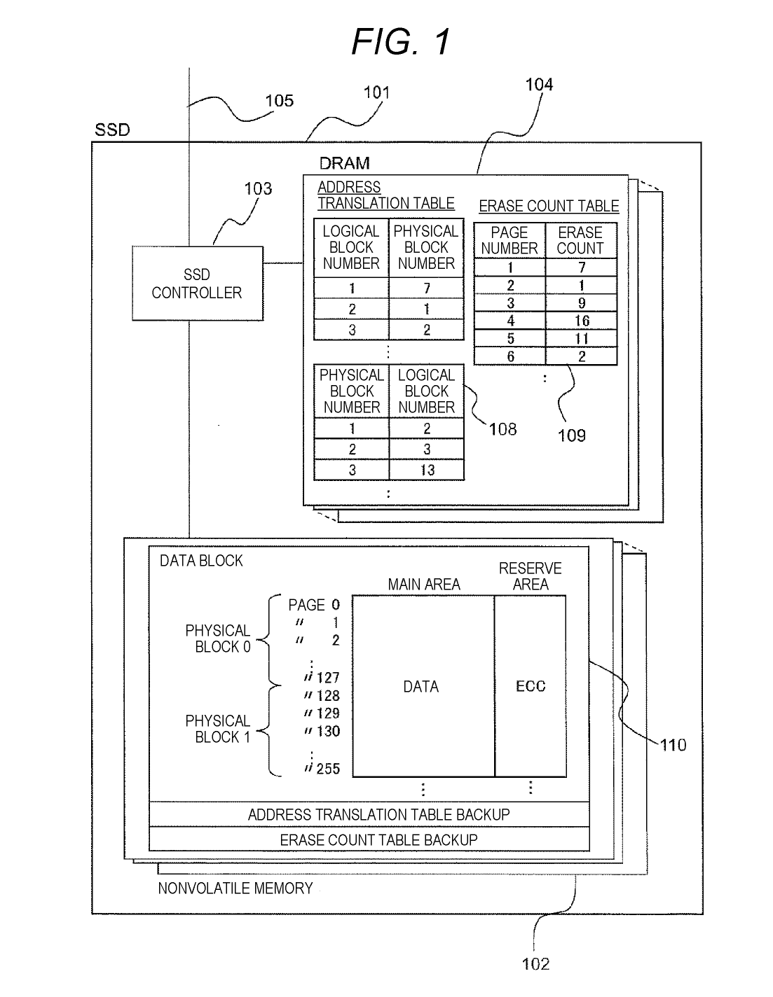

FIG. 1 is a block diagram showing an overall configuration of an SSD according to an embodiment of the present invention. The SSD 101 is connected to various electronics such as a server, a personal computer, and a storage control device (hereinafter referred to as a host) via a host interface 105. The host interface 105 between the SSD 101 and the host is an interface conforming to a publicly known specification used for various interfaces. However, an individual interface specification is also applicable. The storage control device controls storage functions such as volume virtualization, and data backup. The storage control device and the server are connected to each other via a server-storage control device interface.

A nonvolatile memory has a finite number of bit-alterable writes. Therefore, in an SSD, regulation called “wear leveling” needs to be implemented, so as to level the number of bit-alterable writes. In wear leveling, program operations are distributed evenly over the nonvolatile memory, to prevent program operations from concentrating on a particular area, at the time of programming.

The SSD 101 includes the nonvolatile memory 102, an SSD controller 103, a DRAM 104, and the host interface 105, which are provided on a packaging board. The SSD controller 103 controls access to the nonvolatile memory 102 and the DRAM 104.

The SSD controller 103 is able to provide control function compatible with a hard disk to the host. When the SSD controller 103 is hard-disk compatible, the SSD controller is advantageous since it is able to be used with a wide range of the hosts. When the SSD controller 103 is not hard-disk compatible, the host performs control functions so as to conform to the features of the SSD 101. This improves performance of the SSD 101. It is obvious that the host interface 105 is able to have wireless connection as well as wired connection. In the case of wireless connection, flexibility of location of the SSD increases, which favorably reduces the time required for placing the SSD. As the SSD controller 103 performs highly-functional control operation of the SSD, a central processing unit (CPU, not shown) can be incorporated in the SSD controller. Obviously, the SSD can be controlled by hardware of the SSD controller, without placing the CPU in the SSD controller. It is also obvious that the host can perform processing in place of the CPU in the SSD. In such cases, the circuit scale of the SSD controller is small, providing an advantage of cost reduction. A nonvolatile-memory controller (not shown) included in the SSD controller 103 corrects a defective bit in the nonvolatile memory. The nonvolatile-memory controller may have an ECC circuit to secure reliability required of the SSD. The ECC circuit detects and corrects an error of data contained in the nonvolatile memory, for example, by using error-correcting codes (ECC) contained in the nonvolatile memory. It is obvious that an ECC control part is not necessary when the reliability of the nonvolatile memory is higher than the reliability required of the SSD. If this is the case, the circuit scale of the SSD controller 103 is small, providing an advantage of cost reduction. The DRAM and the SSD controller are connected to each other via a DRAM controller (not shown). The DRAM controller can be incorporated in the SSD controller. It is obvious that the DRAM controller can incorporate the ECC circuit, so that the ECC can be added to DRAM data. If this is the case, the SSD reliability improves.

First, a conventional technology is described. In the conventional technology, an address translation table controls a link between a logical page and a physical page. An erase count table controls an erase count for each block number. In addition, a valid/invalid table (not shown) may be provided. The valid/invalid table controls a valid/invalid state of each page. In the conventional technology, a page is equivalent to, for example, a program unit, and does not necessarily need to be larger than an erase unit. In the conventional technology, a block is equivalent to, for example, an erase unit. A valid page means that the page has the possibility to be accessed by the host in the future. An invalid page means that the page has no possibility to be accessed by the host any more. For example, when the host writes data to a logical address 0, the SSD controller writes the data to a logical address 0 (a physical address 0) in the nonvolatile memory. Next, the host writes data to the same logical address 0 again, then the SSD controller writes the data to a physical address 1. At this point, the physical address 1 is a valid page which has the possibility to be accessed by the host through the logical address 0, whereas the physical address 0 is an invalid page which has no possibility to be accessed by the host again. As described above, with the valid-invalid table, an invalid page is effectively erased. Meanwhile, there is an operation called “garbage collection” which is implemented in the following manner: A valid page in a block including an invalid page is read and programmed to another block. Subsequently, the original block is erased, so that an erased block is created. In garbage collection, an erased block is created by erasing the block after a valid page is copied to another block. As a reserve area in the SSD reduces, the proportion of invalid pages increases, raising the number of times of page-copying. This results in a decrease in performance of the SSD, especially write data transfer performance. The largest possible size of data that the host programs to the SSD also decreases.

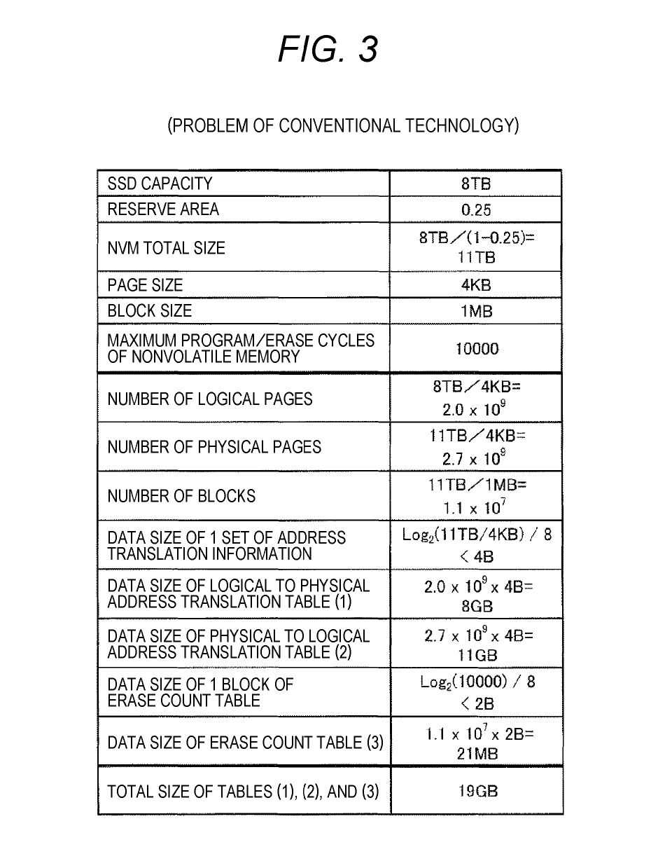

In the conventional technology, address translation is performed in units of pages, while erasure is performed in units of blocks. This causes the following problems: First, the cost of the SSD increases, as a large DRAM capacity is required. Second, the performance of the SSD decreases, due to a large number of table access. FIG. 3 shows an example of a data size of a table used for comparison by the inventors of the present application in an analysis of the problems of the conventional technology. For example, in an SSD with a capacity of 8 TB, the total data size of tables is 19 GB. An increased table-data size leads to an increase in costs of a DRAM and a nonvolatile memory needed to contain the table-data. Moreover, as a larger amount of time is required for table access, the cost of the SSD increases, while the performance of the SSD decreases. As previously described, address translation is performed in units of pages, while erasure is performed in units of blocks. A block is larger than a page. Therefore, the data size of address translation tables, i.e., the total of the data size of 8 GB of table (1) and the data size of 11 GB of table (2) is larger than the data size of an erase count table, i.e., the data size of 21 MB of table (3). Further, the address translation table is bit-alterably written with each update of a page. Also the erase count table is bit-alterably written with each update of a block. As the number of pages is larger than the number of blocks, the write count of the address translation table is larger than the write count of the erase table.

Especially, when the host writes to the SSD continuously, the number of erased blocks reduces, and garbage collection starts. As a result, data transfer performance lowers to approximately 20 to 50% of the initial write operation.

Next, the present invention is described below, with reference to FIG. 1. The nonvolatile memory 102 includes a data block, an address translation table backup, and an erase count table backup. The data size of a page in the nonvolatile memory 102 is 4320 bytes, for example, which is divided into a main area of 4096 bytes and a reserve area (a redundancy part) of 224 bytes, for example. Data is programmed to the main area, and ECC is programmed to the reserve area. The data size of the ECC is 192 bytes, for example. Information in the ECC is used to detect and correct an error of data programmed in the nonvolatile memory. The address translation table and the erase count table contained in the DRAM 104 which is a volatile memory are copied to the nonvolatile memory, during power-off, at regular intervals, or when the SSD is idling, to be stored in the nonvolatile memory as the address translation table backup and the erase count table backup. Making such backup copies at a short time interval reduces the risk of loss of the address translation table and the erase count table due to a sudden power failure and a malfunction of the SSD. On the other hand, if the backup copies are made at a long time interval, the number of access to the nonvolatile memory decreases, then the performance of the SSD improves. For an operation of the SSD, information in the erase count table is of minor importance compared to information in the address translation table. Therefore, backup frequency of the erase count table is lower than that of the address translation table, so that both high performance and high reliability can be achieved in the SSD.

DRAM 104 has the address translation table 108 and the erase count table 109. The address translation table controls a link between a logical block number and a physical block number. For example, the physical block numbers are arranged in order of the logical block numbers. The following is a method for obtaining a physical block number corresponding to the logical block number A: The A-th physical address counted from the first physical address in the address translation table is the desired physical address. Next, the following is a method for obtaining a logical block number corresponding to the physical block number b: Search the address translation table, from the first physical address, for the physical block number b. When the physical block number b is found, count the physical addresses from the first physical address to the physical block number b, then the desired logical block number is obtained. When the DRAM 104 has a table, as the address translation table, in which the physical block numbers are arranged in order of the logical block numbers, but does not have a table in which the logical block numbers are arranged in order of the physical block numbers, the data size of the address translation table is reduced. In such case, the DRAM capacity decreases, so that the SSD is provided at a low cost. In addition, a plurality of the physical block numbers can be linked with the corresponding logical block numbers simultaneously, so that the time required for address translation per physical address can be shortened. Moreover, the DRAM may have, as the address translation table, a physical block-logical block table in which the logical block numbers are arranged in order of the physical block numbers, as well as a logical block-physical block table in which the physical block numbers are arranged in order of the logical block numbers as described above. This achieves high-speed translation from a physical block number to a logical block number, and thus a high-speed SSD is provided. In this case, however, the data size of the address translation table increases, as the address translation table includes both the logical block-physical block table and the physical block-logical block table. As a result, the capacity of the DRAM or the nonvolatile memory increases.

The erase count table 109 is used for controlling an erase count on a page basis. As a method for controlling the erase count, for example, the erase count of a page increases by one, each time the page is erased. As the erase count increases at each time of erasure, the erase count is controlled precisely, so that the SSD with high reliability is provided.

The following method is also applicable: At each erasure, a value for controlling the erase count increases by one, only with a certain probability a. Otherwise, in other words, in the case of a probability of 1−a, the value for controlling the erase count is not changed. Specifically, a random number is generated each time a page is erased, and the erase count increases by one, when the random number is equal to or less than a certain value. When the random number is greater than the certain value, the erase count is not changed. When the erase count is represented by e, and the value for controlling the erase count is represented by f, the erase count e is estimated by the following expression:

erase count e≈value for controlling erase count f/probability a

By this method, the maximum value for controlling the erase count decreases, which reduces the data size required for controlling the erase count. This reduces the capacity of the DRAM, for example, which contains the erase count, so that the cost of the SSD is lowered. The probability a is determined based on, for example, the maximum possible erase count of the nonvolatile memory, and a desired size of data for controlling the erase count. Specifically, when a nonvolatile memory of which the maximum possible erase count is one million is controlled with the desired data size of two bytes, as the largest number represented by 2 B is 65535 (0xFFFF=65535), it is appropriate to use a value of 0.066 as the probability a (65535/1,000,000 times≈0.066). In this case, the erase count of up to one million times can be controlled with the data size of 2 B per page.

Other than the above methods, it may be determined whether the erase count is increased, not increased, or decreased, by one or a value larger than one, based on erasure duration, and erasure result information obtained from the nonvolatile memory when an erase operation is implemented. In this case, detailed state information about the nonvolatile memory is used for controlling the SSD, thus the highly reliable SSD is provided. However, there is also a disadvantage because the operation of the SSD becomes complicated, which results in an extended development period for the SSD. It is obviously possible to determine a certain erase count in a pre-shipment inspection on the SSD, in such a manner that the erase count decreases by one at each time of erasure, whereby the erase count is controlled. In this case, in an example of a nonvolatile memory in which the erased state is represented by ‘1’, and the erase count is controlled in 16-bit units, the erase count is set to 0b1111111111111111=65536, simply with an erase operation in default value setting, for example. With this method, the initial erase count is set in a short time, which reduces production costs.

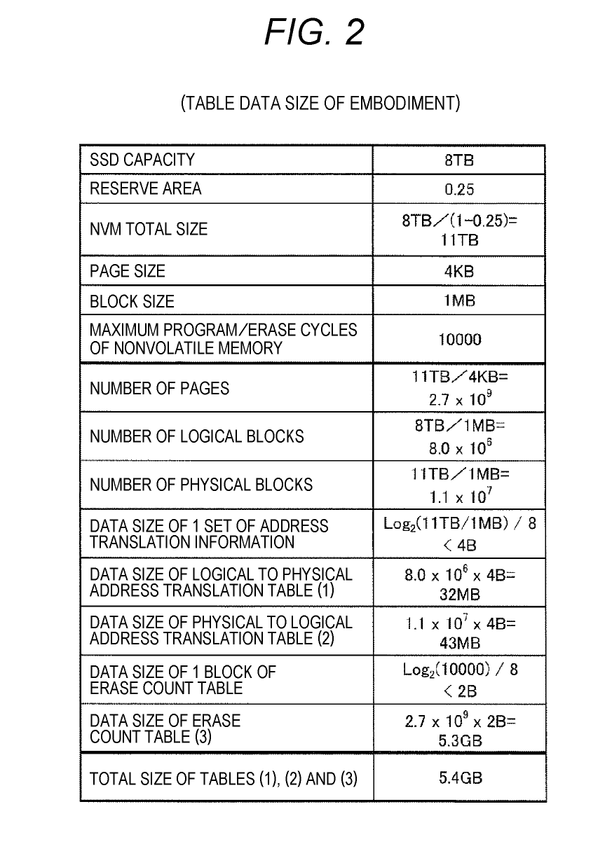

FIG. 2 shows an example of the data size of a table according to the embodiment of the present invention. In an SSD with a capacity of 8 TB, the total size of data of tables is 5.4 GB. The total size is smaller than that of 19 GB of the conventional technology, reducing the costs of the DRAM and the nonvolatile memory which contain the data of the tables. In addition, an amount of time required for table access is shortened, which lowers the cost of the SSD, while improving the performance of the SSD. As previously described, address translation is performed in units of blocks, while erasure is performed in units of pages. A page is smaller than a block. Therefore, the data size of address translation tables, i.e., the total of the data size of 32 MB of table (1) and the data size of 43 MB of table (2) is smaller than the data size of an erase count table, i.e., the data size of 53 GB of table (3). In other words, the data size of information used for address translation is smaller than the data size of information used for erase count control. Further, the erase count table is bit-alterably written with each update of a page. Also the address translation table is bit-alterably written with each update of a block. As the number of pages is larger than the number of blocks, the write count of the erase table is larger than the write count of the address translation table.

When the capacity of the DRAM per chip is 4 Gb, for example, 38 DRAM chips are needed to contain the table data of 19 GB in size in the conventional system. In the present disclosure, however, 11 DRAM chips are sufficient to contain the same size of data. As the required number of chips decreases, configurations of the DRAM controller and an SSD circuit board are simplified, as well as reducing the cost of a DRAM chip. As a result, the cost of the SSD lowers significantly.

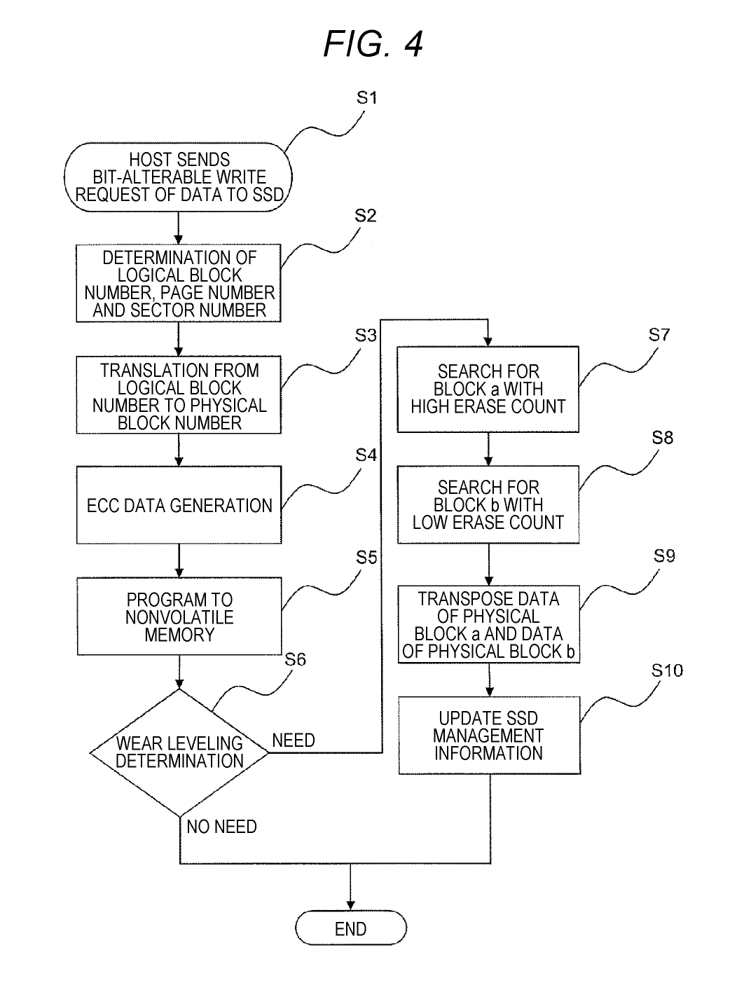

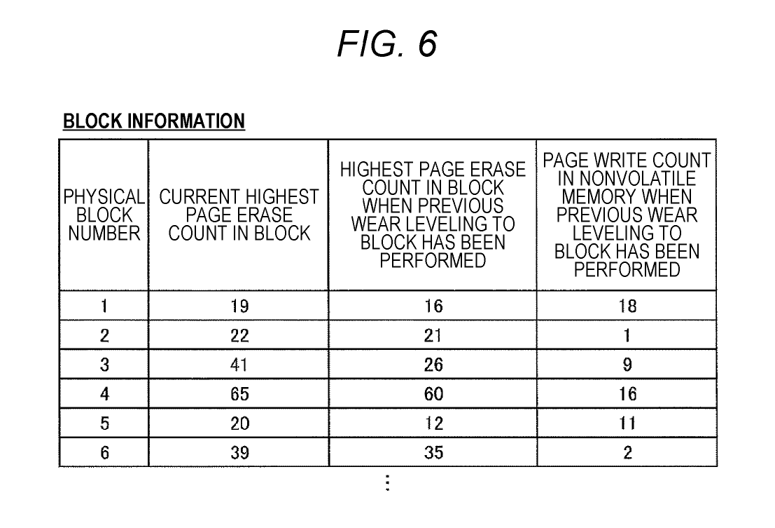

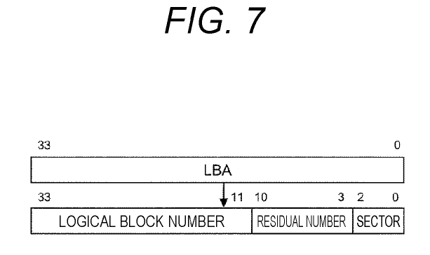

Operations of the SSD 101 are described below, with reference to FIG. 4. First, write operation is described. In order to implement the write operation, information of the SSD is controlled by means of a table for controlling block information shown in FIG. 6, in addition to the tables shown in FIG. 1. The host sends a request to bit-alterably write data with respect to a logical address A, to the SSD 101 via a host interface 105 (S1). The SSD controller determines a logical block number, a page number, and a sector number d based on the logical address A (S2). FIG. 7 shows a specific example with the SSD capacity of 8 TB, the page size of 4 KB, and the block size of 1 MB. The host specifies a logical address by logical block addressing (LBA). The logical block number B is [33:11] which corresponds to the upper 23 bits of the LBA address. The LBA address number [10:3] is a residual number. The address [2:0] is assigned to the sector. Subsequently, the SSD controller refers to the B-th item in the logical-physical translation table. A value in the B-th item is a physical block number b (S3). The page number c is obtained by the following expression (1):

page number=physical block number×256+residual number (1)

Then, the SSD controller generates ECC corresponding to the data to be bit-alterably written (S4), and bit-alterably writes a sector d of the obtained page number c (S5). A detailed description of the operation is given below. In the case of a nonvolatile memory which requires an erase operation, when the SSD controller bit-alterably writes an entire page, the SSD controller erases the page before programming the data sent by the host. When the SSD controller bit-alterably writes a sector which is part of a page, the SSD controller reads data in a sector other than the sector to be bit-alterably written before erasing the entire page. The SSD controller combines the data in the sector other than the sector to be bit-alterably written with the data sent by the host into one page of data, then programs the data (this is called read-modify-write operation). In the case of a nonvolatile memory in which a bit-alterable write operation is implemented without requiring an erase operation (a directly-overwritable nonvolatile memory), the SSD controller simply bit-alterably writes data in a sector specified by the host. However, if ECC process is executed in units of pages, for example, not in units of sectors, the SSD controller bit-alterably writes ECC data in addition to the data in the sector specified by the host. When a page erase count exceeds the highest page erase count of a block shown in FIG. 6, the SSD controller updates “current highest page erase count in block” in the block information.

Subsequently, the SSD controller determines whether or not to perform wear leveling (S6). For example, the SSD controller performs wear leveling when a write amplifier factor (WAF) is equal to or less than 1.01. A WAF is obtained by dividing a size value of data which the SSD has programmed to the nonvolatile memory by a size value of data programmed by the host.

When wear leveling is not performed, the write operation is terminated. When wear leveling is performed, the SSD controller, first, searches for a physical block a having a high erase count (S7). However, if a physical block with a high erase count is simply selected for wear leveling, the same physical block may continuously be selected for wear leveling. Therefore, the SSD controller searches, for example, for a physical block a having a page with the largest increase in the erase count from the previous wear leveling of the physical block. In the example shown in FIG. 6, the physical block 3 is selected, because the value obtained by subtracting “highest page erase count in block when previous wear leveling to block has been performed” from “current highest page erase count in block” is the largest in the physical block 3, among physical blocks 1 to 6.

Next, the SSD controller searches for a physical block b having a low erase count (S8). However, if a physical block with a low erase count is simply selected for wear leveling, the same physical block may continuously be selected for wear leveling. Therefore, the SSD controller searches, for example, for a physical block in which a certain period of time has elapsed after the previous wear leveling. To estimate the period of time, the number of pages programmed to the nonvolatile memory is used. Specific search procedure is described with reference to FIG. 6. First, it is decided that a physical block is not wear-leveled until data is programmed in the entire nonvolatile memory 90 times after the previous wear leveling of the physical block. Obviously, the numerical value of 90 is merely an example for explanation. Actually a much larger value of approximately one hundred million is used. Other numerical values are also used simply as examples. When the page write count in the nonvolatile memory at the time of wear leveling is 200, the SSD controller searches for a block which satisfies the following conditions: “page write count in nonvolatile memory when previous wear leveling to block has been performed” is equal to or more than 90, i.e., 200−110, and at the same time, “current highest page erase count in block” is the smallest. In the example shown in FIG. 6, the block 5 is selected.

After that, the data of the physical block a and the data of the physical block b are replaced by each other (S9). Specifically, for example, the SSD controller reads the data of the physical blocks a and b temporarily into a buffer of the SSD controller. When the nonvolatile memory is directly-overwritable, the SSD controller programs the data of the physical blocks a and b to the physical blocks b and a, respectively. When the nonvolatile memory is not directly-overwritable, the SSD controller erases the physical blocks a and b, before programming the data of the physical blocks a and b to the physical blocks b and a, respectively.

Alternatively, when the SSD has a write-back cache, the data of the physical blocks a and b can be programmed into the cache. The logical block number needed for this process is obtained by searching the physical-logical address translation table. The data stored in the cache is written back to the nonvolatile memory after a certain period of time, following cache refill which means updating cache data. The write-back cache can be placed in the DRAM or the nonvolatile memory in the SSD, a static random access memory (SRAM) or a DRAM in the SSD controller, and a DRAM, a nonvolatile memory in the host. When the write-back cache or management information thereof is located in a volatile memory, it is desirable for the memory to have a configuration to prevent loss of data thereof in the event of power supply loss, by means of a battery backup, a super capacitor, and the like.

Finally, the SSD controller updates SSD management information (S10), and terminates the write operation with wear leveling.

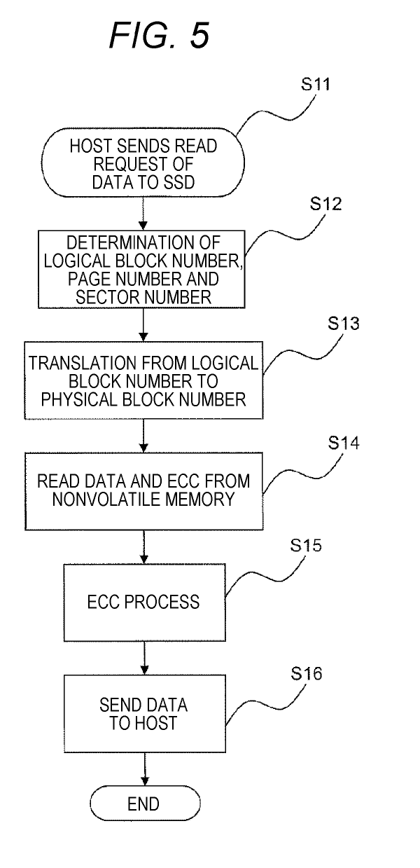

Next, read operation is described below, with reference to FIG. 5. The host sends a request to read data with respect to a logical address A, to the SSD 101 via a host interface 105 (S11). The SSD controller determines, as in the case in the write operation, a logical block number, a page number, and a sector number d based on the logical address A (S12). Further, the SSD controller acquires a physical block number from the logical block number (S13).

Subsequently, the SSD controller reads the sector d of the page number c obtained by the above method, and the ECC (S14). The SSD controller performs error detection and correction by means of the ECC (S15), then sends the data to the host (S16). It is obvious that copying read data in the cache improves the performance of the SSD.

The disclosure is more effective than the conventional technology, especially when the erase unit of the nonvolatile memory is small, and the size of data programmed at the time of access from the host to the SSD is large.

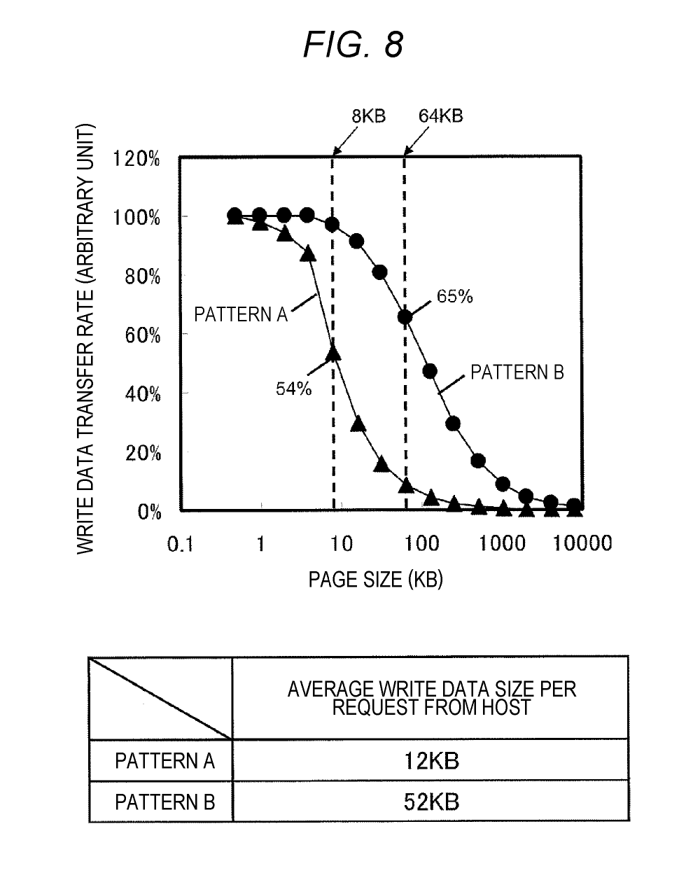

A specific example is described below, with reference to FIG. 8. FIG. 8 shows an estimate of the write data transfer performance of the SSD configured according to a system of the present disclosure.

In a pattern A, an average data size per request from the host is 12 KB. In a pattern B, an average data size per request from the host is 52 KB. In the graph, page size is plotted on the horizontal axis, against write data transfer rate on the vertical axis. Here, the write data transfer performance is 100% when the erase unit is 0.5 KB which is the minimum specifiable data size by the LBA method. In order to achieve the write data transfer rate of 50% or more, the page size is required to be 8 KB or less in the pattern A, and 64 KB or less in the pattern B. As can be seen in FIG. 8, when the page size is small, the write data transfer performance of the embodiment is high. Additionally, compared to the pattern A, with the same page size, the write data transfer performance is higher in the pattern B where the size of data programmed at the time of access from the host to the SSD is large. Analysis on various patterns sent from the host shows that a high performance yet low cost SSD is provided by the embodiment of the invention, especially when the largest page size is 64 KB or less. Here, the page size means the smallest unit of any one of program, bit-alterable write, and erase operations to the nonvolatile memory. Meanwhile, as a nonvolatile memory in which the unit of bit-alterable write or erase operation is 64 KB or less, a phase change memory and a ReRAM are developed and produced. The embodiment of the present invention is especially effective when a phase change memory or a ReRAM are used as a nonvolatile memory. Particularly, a large-capacity SSD is provided by using a phase change memory as a nonvolatile memory. Also, a high-speed SSD is provided by using a ReRAM as a nonvolatile memory, since a ReRAM is fast at bit-alterable write operation.

In the meantime, when the inventors of the present application studied patterns for video editing purposes, it was found that an average write size from the host was 1 MB, and sometimes data area for each request was contiguous with another. In such case, the SSD controller is able to combine multiple write requests, to process the requests combined as one write request with a write size of more than 1 MB. The erase unit of a NAND flash memory is 512 KB, for example. In this case, with the page size of 512 KB and the block size of 4 MB, SSD management information is reduced. This provides a high performance yet low cost SSD which is applicable in video editing and so forth.

The inventors examined in detail the influence of the address translation unit and erase unit of the SSD on the SSD performance, in terms of various address translation units, erase units, and patterns of access from the host to the SSD. As a result, the inventors found the following: When the erase unit is small (to be more precise, when the erase unit is equal to or smaller than the data size of access from the host to the SSD), there is no significant decrease in the write data transfer performance of the SSD and the maximum size limit of data that can be programmed to the SSD, even if the address translation unit is larger than the erase unit. In some cases, the SSD is superior to a conventional technology in terms of the write data transfer performance and the maximum size limit of data that can be programmed to the SSD.

More specifically, as an erase unit of a NAND flash memory is larger than the usual data size of access from the host to the SSD, in the case of the SSD using the NAND flash memory as a nonvolatile memory, the SSD is effective especially when the data size of access from the host to the SSD is larger than the usual size, or when write frequency is lower than read frequency compared to the usual case. Therefore, the embodiment of the present invention is effective especially when the SSD is used in video editing and the like, as mentioned above. On the other hand, when a phase change memory, a ReRAM, or a STT-MRAM of which the erase unit is small is used as a nonvolatile memory, the SSD with high performance is provided for general use, by the embodiment of the present invention. At present, a NAND flash memory is commonly used as a nonvolatile memory in an SSD, whereas a phase change memory, a ReRAM, or a STT-MRAM is used for a relatively specific purpose. The embodiment was conceived based on the above-described knowledge.

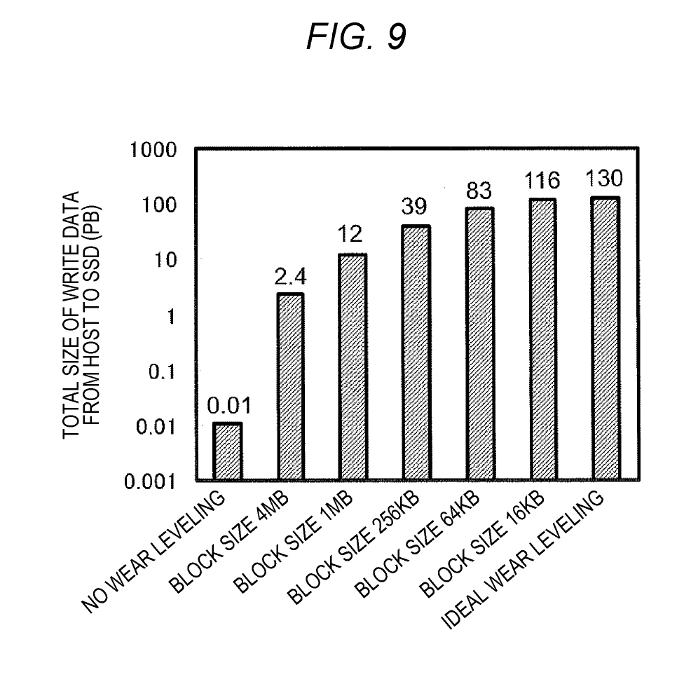

Given below is a description of the block size and the SSD lifespan, with an example shown in FIG. 9. FIG. 9 is a diagram showing the relationship between the block size and the total size of data the host has written to the SSD until the end of life of the SSD, under the following condition: the page size of 4 KB; the SSD capacity of 8 TB; the provisional area of 25%, and the maximum erase count of the nonvolatile memory of 100,000.

When “ideal wear leveling” refers to a state in which write data sent by the host is ideally leveled to be programmed completely evenly to all pages in the nonvolatile memory, in the “ideal wear leveling” with the above conditions, the SSD comes to an end of life thereof when 130 PB of data has been programmed to the SSD by the host, and bit-alterable writing of data in the SSD is no longer possible. As the block size increases, the data size of the address translation table decreases, and in addition, the length of time required for address translation is shortened. This provides a low cost, high performance, and long life SSD. Further, the host mainly sends a read request, while the number of times of write to the SSD is small. Therefore, if the SSD is not required to have a long life, a low cost ant high performance SSD is provided by the embodiment of the present invention, even when the block size is, for example, 64 KB or more.

Further, generally speaking, it is desirable to specify the block size in the embodiment of the present invention depending on characteristics of a pattern to be programmed to the SSD, such as the maximum erase count of the nonvolatile memory, the operation guarantee period of the SSD, estimated write data size per day in the SSD, and data size per request. For example, when the block size is 1 MB, the upper limit on the size of write data to be programmed to the SSD by the host is 12 PB. Assuming that the SSD is used for five years, the size of data that can be programmed to the SSD is 6.7 TB per day on average. Therefore, the SSD is able to operate with high reliability, even with the block size of 1 MB, provided that the write data size is less than 6.7 TB a day.

In conclusion, the semiconductor storage according to the first embodiment achieves advantageous effects described below. In the following description, “SSD management information” means information which is not directly referenced by the host. The address translation table and the address translation table backup are included in the SSD management information. However, ECC is excluded.

First, the data size of the SSD management information is reduced. Accordingly, capacities of the DRAM and the nonvolatile memory decrease, while the capacity of the SSD remains the same. As a result, the SSD is provided at low cost.

Second, as the data size of the SSD management information is reduced, frequency of access to the SSD management information is decreased. As a result, the SSD with high performance is provided.

Third, the reserve area can be reduced, while the performance of the SSD is maintained. As described earlier, in the conventional system, WAF rises when the reserve area is reduced, which means the size of write data to the nonvolatile memory increases. On the other hand, in the present disclosure, garbage collection is not performed, thus write data transfer rate is not changed when the reserve area is reduced. As a consequence, the reserve area can be reduced, while the performance of the SSD is maintained. In other words, the capacity of the nonvolatile memory decreases, while the capacity of the SSD remains the same. As a result, the SSD is provided at low cost.

Fourth, the performance of the SSD improves, as garbage collection is not required in the present disclosure, although it is necessary in the conventional system. In the conventional system, wear leveling is implemented with a combination of dynamic wear leveling, static wear leveling, and garbage collection. The wear leveling operations described in the present disclosure are close to those of the static wear leveling method applied to the conventional system.

The SSD provided by the present disclosure maximizes the performance of a phase change memory and a ReRAM, especially making effective use of their small erase units. However, it is obviously possible to provide the SSD according to the present disclosure by using a NAND flash memory as a nonvolatile memory, depending on a configuration and performance of the NAND flash memory, and a data pattern sent by the host to the SSD. The SSD of the present disclosure is effective when used with a NAND flash memory especially for the purpose of editing, playing, and streaming of video, photographs, and music, as an average data size per request from the host to write to the SSD is large. The SSD of the present disclosure is also effective especially in storing online commerce database and the like, with respect to which read access is more frequent than write access.

### Second Embodiment

The following is a description of a second embodiment. There is given another example of a block configuration and operation of an SSD. In such SSD, each block has an offset page number for the purpose of leveling or removing disparity in erase count of the block.

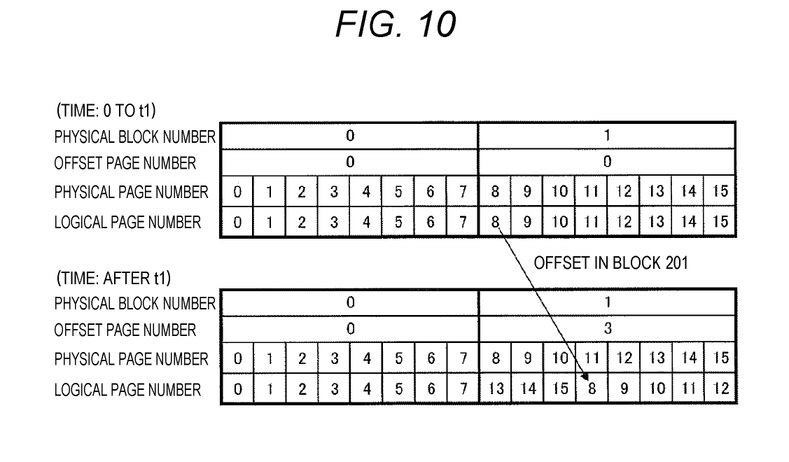

FIG. 10 is a diagram showing a relationship between a block and pages, and an offset in the block, according to an embodiment of the present invention.

The offset page number is controlled for each physical block. The offset page number is zero in each of the physical blocks 0 and 1, from a time t0 to a time t1. For example, a physical page 8 corresponds to a logical page 8. Then, the physical block 1 has the offset of three pages at the time t1, so that the physical block 1 is in a state of “offset in a block 201”. Therefore, the physical page 8 corresponds to the logical page 11, for example, after the time t1. As described above, a particular physical page is prevented from increasing in the erase count by changing the offset page number. This makes it possible to implement wear leveling within a block.

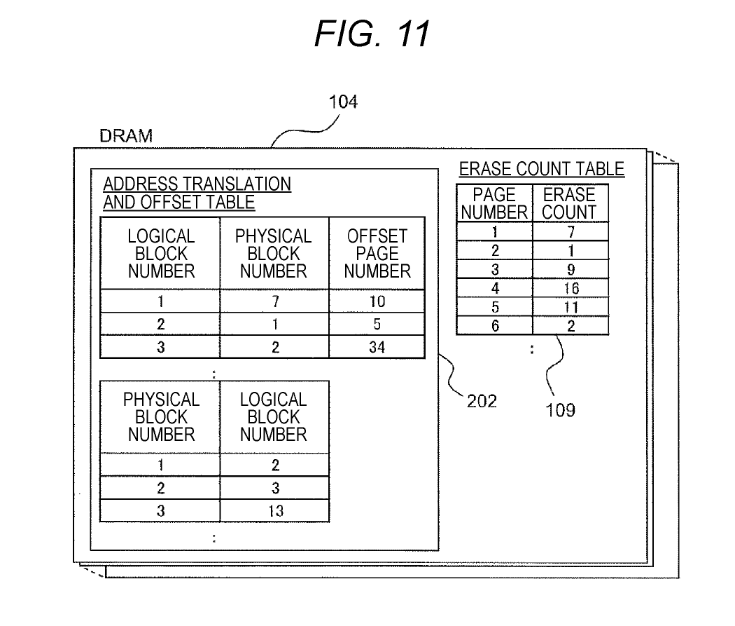

FIG. 11 is a block diagram showing a configuration of a DRAM 104 in the SSD. The DRAM has an address translation and page offset table 202, and an erase count table 109. The address translation and page offset table 202 controls the offset page number in each logical block, along with, for example, a logical block-physical block translation table, and a physical block-logical block translation table. Obviously, the physical block-logical block translation table can be omitted.

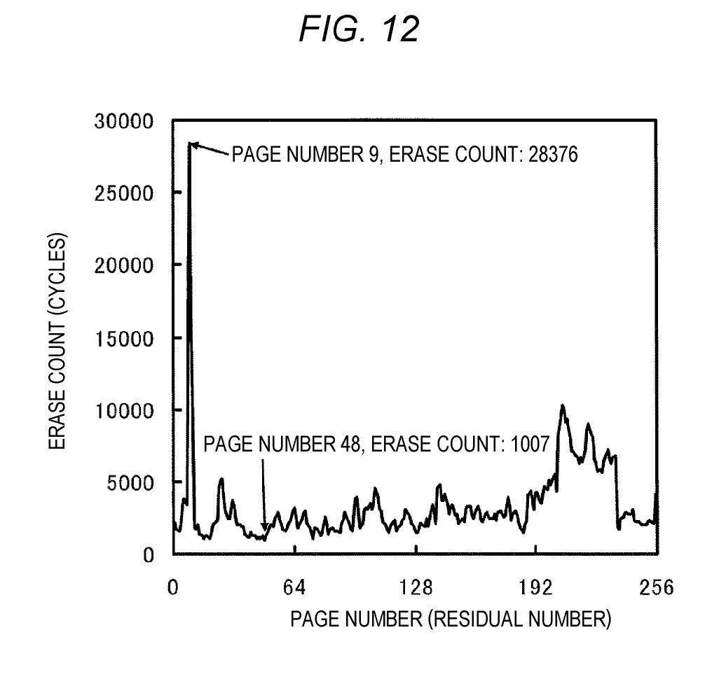

FIG. 12 is a diagram showing erase count for each page in a certain block, in the form of a pattern obtained by the inventors of the present application under the condition of the first embodiment with the page size of 4 KB and the block size 1 MB. While the erase count in page 9 is high (28376 cycles), the erase count in page 48 is low (1007 cycles). The erase count in page 9 is 28 times as many as that of page 48, which shows a great difference. Further analysis showed that pages with high erasure counts concentrated in a particular residual number. The inventors conceived an idea of leveling the erase counts in the block so as to extend the lifespan of the SSD, and devised the SSD according to the second embodiment. Here, a page number before offset is the logical page number, and a page number after offset is the physical page number.

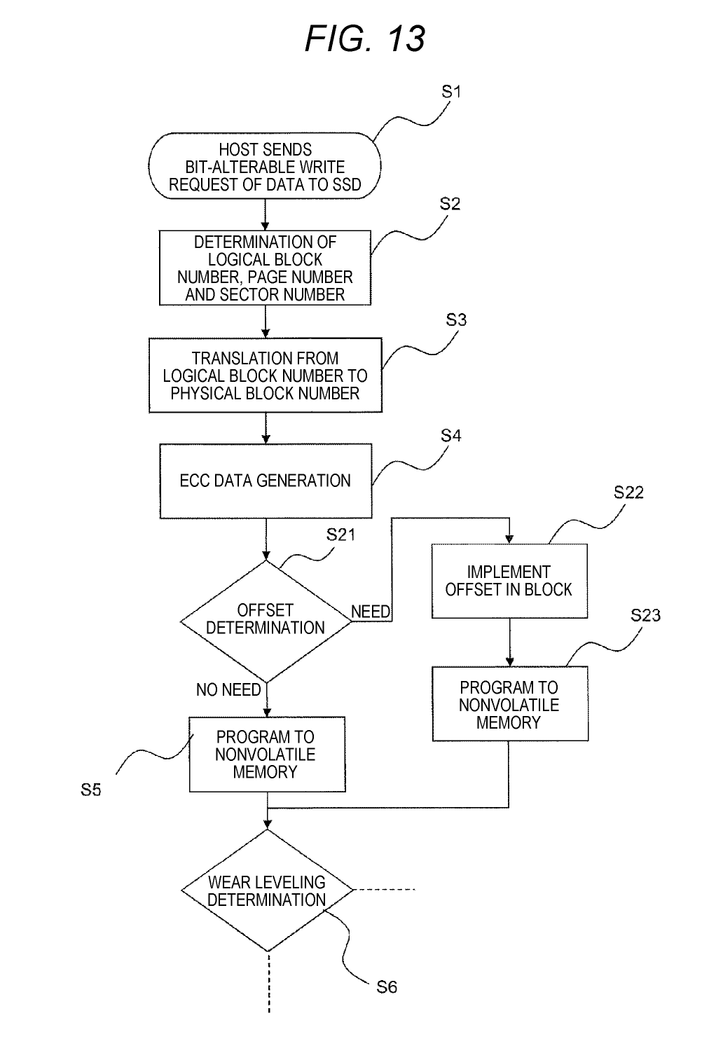

Next, write operation of the SSD in which each block has an offset page number is described below, with reference to FIG. 13.

The description of S1 to S5 is the same as in the first embodiment, and is not repeated here. In determination of offset (S21), the SSD controller compares the highest and the lowest page erase count in a block. When the difference between the erase counts is equal to or more than a certain value, the SSD controller changes the offset page number. The SSD controller can perform the offset simply to bit-alterable write an area in the block, when the data size of the area is equal to or more than a certain threshold.

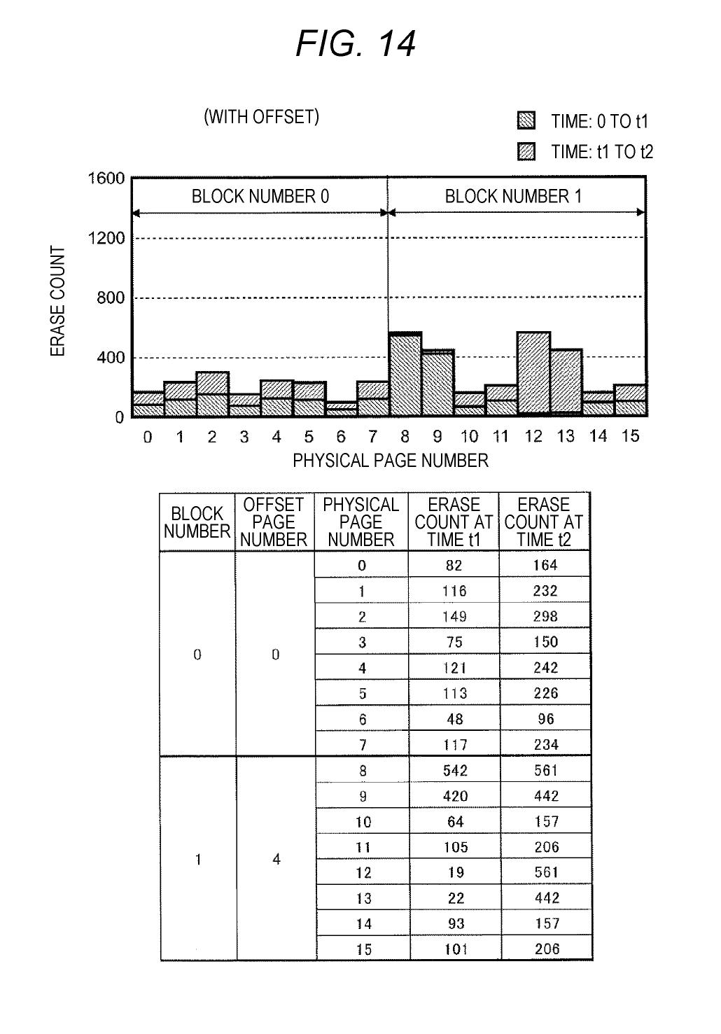

Subsequently, the SSD controller changes the offset page number (S22). Specifically, FIG. 14, for example, the erase count of each physical page in a block is obtained with respect to each of the offset page numbers 0 to 7, one of which is selected to be a new offset page number at the time t1. Then, the erase count obtained as above and the corresponding current erase count of the each physical page are added together. The offset page number which meets the following requirement is selected as the new offset page number: The largest sum of the two erase counts in the block has the smallest value among such largest sums obtained with respect to the offset page numbers 0 to 7.

Further, the SSD controller reads data in a page other than a page that the host has instructed the SSD controller to bit-alterable write. Then the SSD controller combines the data read from the page with the data sent by the host into one block of data, then programs the data to the nonvolatile memory (S23). The rest operations are the same as the first embodiment.

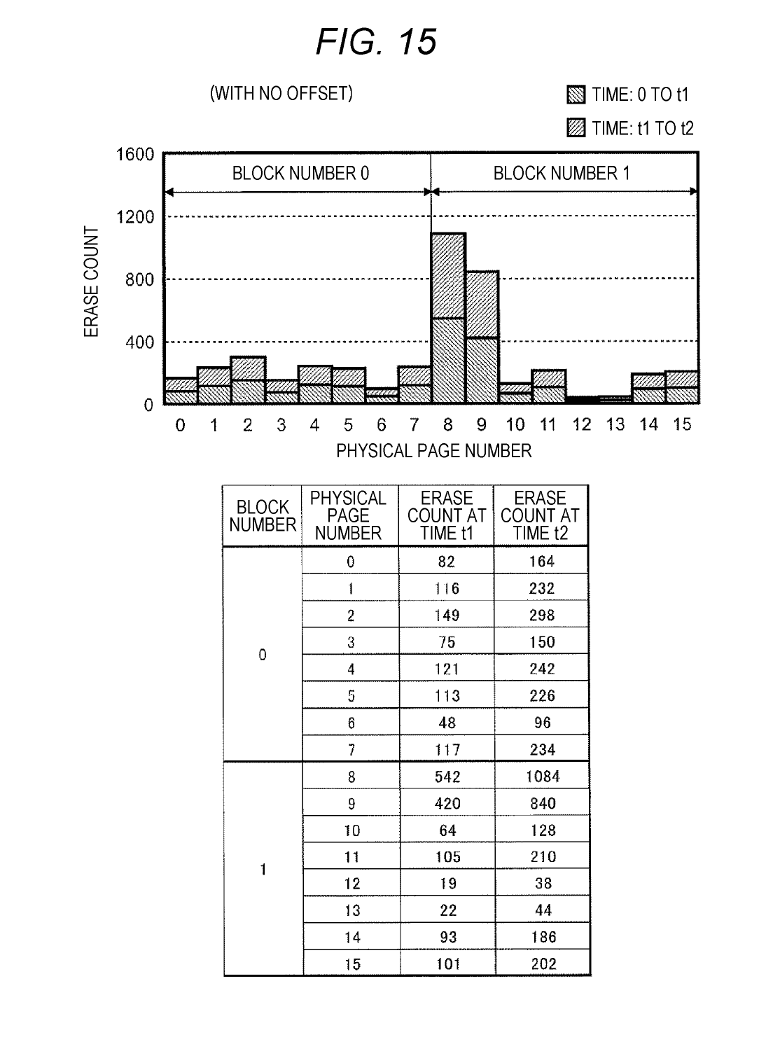

FIG. 14 shows that a program operation mentioned in FIG. has been done by the time t1. When a program operation is performed in the same method as the previous operation between the times t1 and t2, the highest erase count is 561, with the offset page number of 4. FIG. 15 shows an example of a program operation without offsetting. In this case, the largest erase count at the time t2 is 1084, which is higher than the case with offsetting. This means the largest erase count is decreased with the configuration of the second embodiment. As a result, a highly reliable SSD is provided.

### Third Embodiment

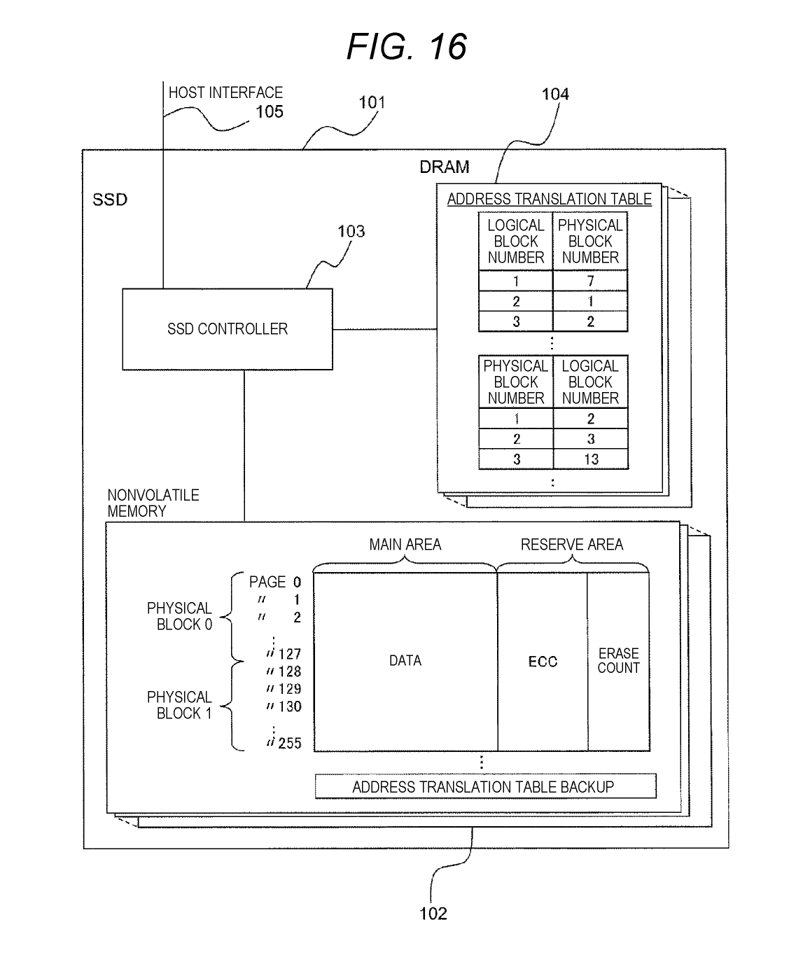

In a semiconductor storage according to a third embodiment, erase count is stored in a reserve area provided in a nonvolatile memory. FIG. 16 shows a configuration of the SSD according to the third embodiment. In this configuration, a DRAM does not have an erase count table, while an ECC and the erase count are contained in the reserve area in the nonvolatile memory.

The nonvolatile memory has a main area which mainly stores data, and the reserve area which mainly stores management information of the data. For example, the data size per page in the main area is 4096 B, and the reserve area 224 B. The reserve area can store the ECC which is used for correction and detection of an error of the data in the main area. In the embodiment, the reserve area stores erase count in addition to the ECC. The data size per page in the ECC is 196 B, for example, and the erase count 2 B, for example.

As the erase count is stored in the reserve area, accessing to the memory for simply updating the erase count is not necessary. The erase count is changed only at the time of bit-alterable write to the nonvolatile memory, that is, when data is programmed to the nonvolatile memory. Therefore, the erase count is updated at the same time as the data is programmed. Obviously, the erase count can be increased or decreased in a read operation, for example, based on information obtained from the nonvolatile memory, such as the number of errors detected.

With this embodiment, a low cost SSD is provided, as it is not necessary to contain the erase count table in the DRAM 104. At the same time, a high performance SSD is provided, as the number of access to the memory is reduced.

### Fourth Embodiment

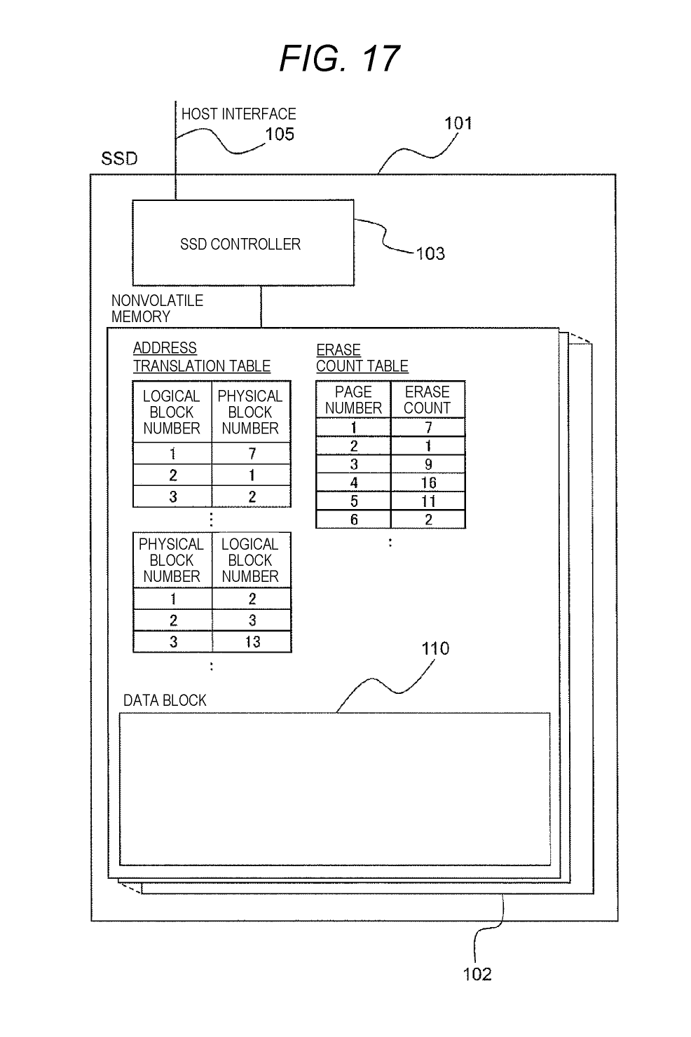

In a semiconductor storage according to a fourth embodiment, an SSD does not have a DRAM, and an erase count table is contained in a nonvolatile memory. FIG. 17 shows a configuration of the SSD according to the fourth embodiment.

With no DRAM, this configuration is advantageous in that the cost of the SSD is reduced. What is more, there is no need to provide a battery backup to the DRAM to prevent information loss of the DRAM which is a volatile memory in the event of a sudden power failure. This further reduces the cost of the SSD.

### Fifth Embodiment

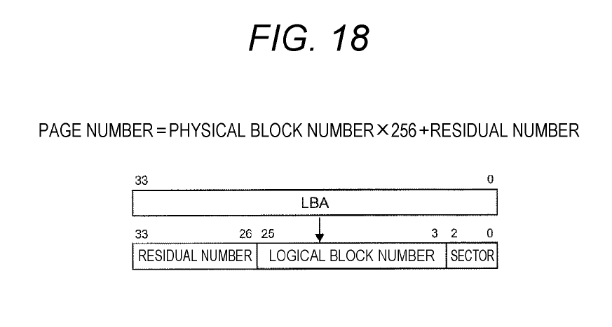

In a semiconductor storage according to a fifth embodiment, a different computation method is used in a procedure for obtaining a logical block number, a residual number, and a sector from an LBA (S3). FIG. 18 shows the computation method.

In the first embodiment, a logical block number is obtained by using high-order bits of an LBA address. In the fifth embodiment, a residual number is obtained by using high-order bits. Thereby, disparities of erase count in a block are removed. It is not always needed to place the residual number in the highest bits [33:26] with the logical block number placed in bits [25:3]. For example, it is possible to allocate bits [30:23] to the residual number, and connect bits [33:31] and bits [22:3] to be allocated to the logical block number. In this case, it is easy to assign a particular block of the SSD to a control area, so that the time required for designing the SSD is shortened.

With this embodiment, a highly reliable yet low cost SSD is provided, as the lifespan of the SSD is prolonged with no need for an additional memory.

### Sixth Embodiment

The following is a description of a sixth embodiment, in which an address translation table and an erase count table are placed in an area other than a DRAM.

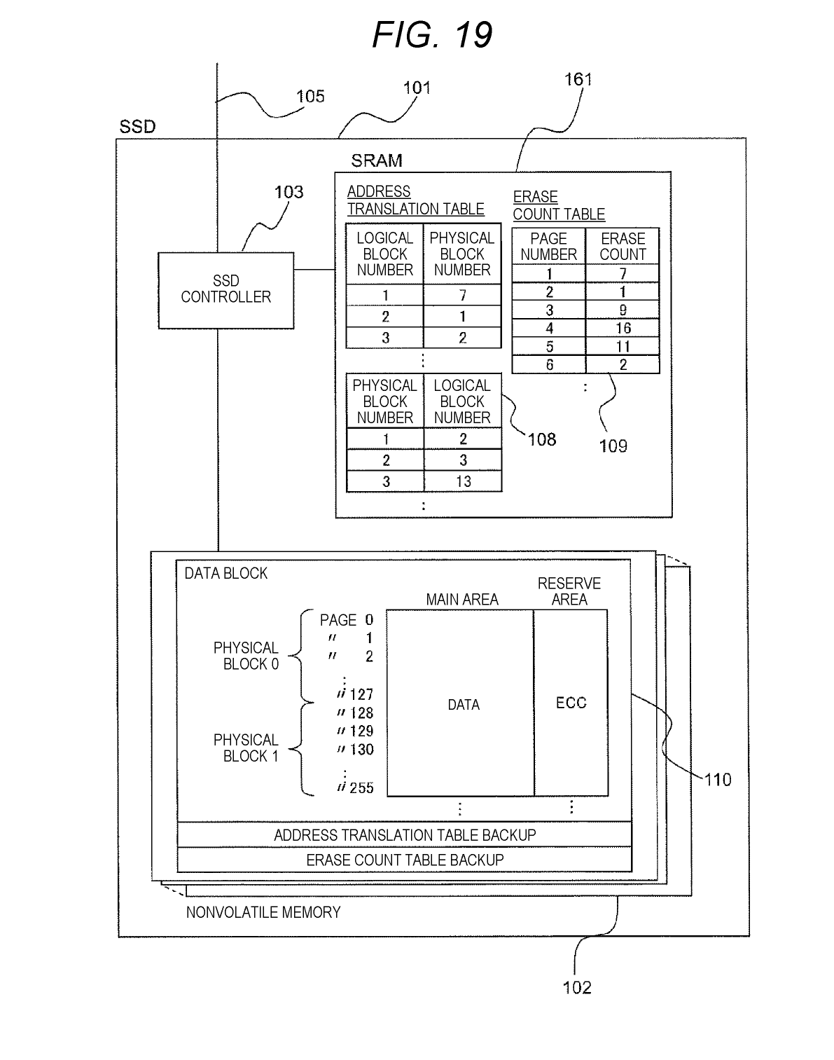

In a semiconductor storage shown in FIG. 19, the address translation table and the erase count table are located in an SRAM 161. A configuration diagram is shown in FIG. 19. As SRAM access latency is lower than DRAM access latency, operation speed of the SSD increases.

The SRAM can be placed on the same chip as the SSD controller. This reduces the production cost of the SSD. It is obviously possible to form the SSD controller of multiple chips which operate collaboratively. On the other hand, the SRAM can be placed on a chip different from a chip of the SSD controller. In such case, a large capacity SRAM can be used, which enables the nonvolatile memory 102 to be controlled in smaller units. As a result, longevity of the SSD is achieved.

The address translation table and the erase count table can also be placed in an MRAM (not shown) instead of an SRAM.

Different from DRAM, MRAM is a nonvolatile memory, which needs no secondary power supply to prevent data loss due to an abrupt power failure and the like, or needs at most a small capacity of power supply. Therefore, the SSD is produced favorably at low cost.

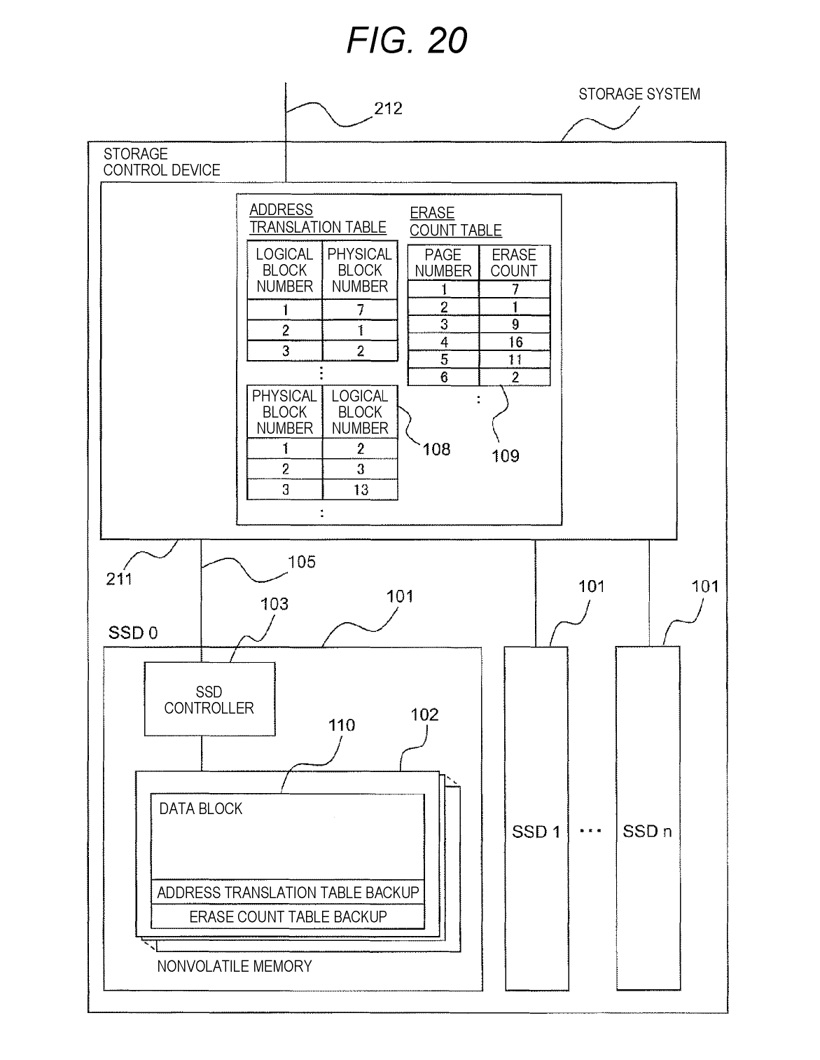

Additionally, as shown in FIG. 20, the address translation table and the erase count table are placed in a storage control device 211. The address translation table and the erase count table are usually provided in each of the multiple SSDs. In this case, however, the tables are placed in one location together. This reduces the cost of a battery or the like used to protect table data. A system including multiple SSDs and a storage control system shown in FIG. 20 is referred to as a storage system. The address translation table and the erase count table are able to be placed in a DRAM in the storage control device 211. Obviously, a single level cell (SLC) NAND flash memory, a multi-level cell (MLC) NAND flash memory, an MRAM, and an SRAM are able to contain the tables. It is also obvious that the SSD is able to have a DRAM. A fast SSD is provided, with the DRAM having a data cache.

As previously described, the storage control device 211 controls data redundancy for the purpose of reliability improvement, by using RAID or redundant-arrays-of-inexpensive/independent-disks technology and the like, as well as controlling a backup function, a snapshot function, and a deduplication function.

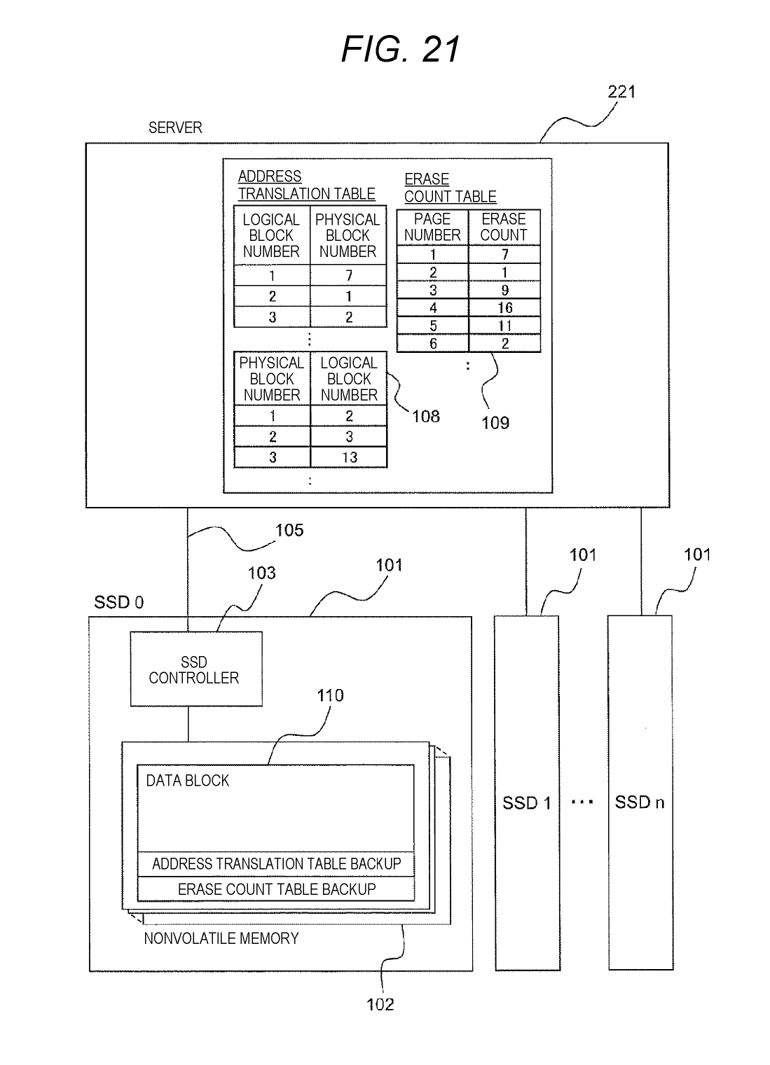

Furthermore, as shown in FIG. 21, the address translation table and the erase count table are able to be placed in a server 221. This decreases the data size of SSD management information in the SSD. Accordingly, the DRAM provided in the SSD in order to store the SSD management information is diminished in data size, or can be removed. Alternatively, the data size of the nonvolatile memory in the SSD is reduced, without changing the SSD capacity. As a result, the cost of the SSD is lowered.

In the above case, it is desirable for the host interface 105 to use an individual protocol, such that the host has increased flexibility in controlling the SSD. This enables, for example, the host to erase unnecessary data in the nonvolatile memory at a proper timing, such as an idling time of the host. As a result, a high performance SSD is provided.

It is obviously possible to place the storage control device and a cache controller between the SSD and the server. This configuration offers a storage function such as a snapshot capability, a function which enables multiple servers to share a cache, and so on. When neither the storage control device nor a cache controller is placed between the SSD and the server, a low cost computer system is provided.

### REFERENCE SIGNS LIST

101 SSD
102 nonvolatile memory
103 SSD controller
104 DRAM
105 host interface
108, 111 address translation table
109, 112 erase count table
161 SRAM
202 address translation and page offset table
211 storage control device
212 server-storage control device interface
221 server

1. A semiconductor storage comprising:
a nonvolatile memory in which a storage area is segmented into multiple blocks, and each of the blocks are segmented into multiple pages,
wherein an erase count is controlled in units of the pages, and
address translation from a logical address into a physical address is implemented in units of the blocks.

2. The semiconductor storage according to claim 1, wherein a data size of information used for address translation is smaller than a data size of information used for controlling the erase count.

3. The semiconductor storage according to claim 1, wherein the number of writes to an erase count table is larger than the number of writes to the address translation table.

4. The semiconductor storage according to claim 1, wherein erase count leveling is performed in the block.

5. The semiconductor storage according to claim 4, wherein an offset page number is used when the leveling is performed in the block.

6. The semiconductor storage according to claim 1, wherein
the page individually has a main area and a reserve area, and
when data is programmed to the main area of the page, the erase count of the page is programmed to the reserve area of the page.

7. The nonvolatile storage device according to claim 1, wherein, further, an erase count is stored in a reserve area of the nonvolatile memory according to claim 1.

8. The semiconductor storage according to claim 1, wherein, when the page is erased, a value used to store the erase count is increased by 1, with a specific probability of less than 1.

9. The semiconductor storage according to claim 1, wherein a storage control device or a server implements the address translation.

10. The semiconductor storage according to claim 1, wherein the nonvolatile memory is a phase change memory or a ReRAM.

11. The semiconductor storage according to claim 1, wherein the block unit is equal to or more than 64 KB.

12. A storage system comprising the semiconductor storage of claim 1.
